(19) United States
(12) Patent Application Publication
(10) Pub. No.: US 2014/0358696 A1
(43) Pub. Date: Dec. 4, 2014

(54) ADVERTISEMENT SYSTEM USING RETAILER INVENTORY

(71) Applicant: Microsoft Corporation, Redmond, WA (US)

(72) Inventors: Karen Master Ben-Dor, Tel Aviv (IL); Kfir Karmon, Tel Aviv (IL); Yagil Engel, Tel Aviv (IL)

(21) Appl. No.: 13/908,288

(22) Filed: Jun. 3, 2013

(51) Int. Cl. G06Q 30/02

(52) U.S. Cl. CPC G06Q 30/0241
USPC 705/14.71; 705/14.4

(57) ABSTRACT

An advertisement system which uses a retailer inventory is described, for example, to dynamically generate advertisements with data from the retailer inventory. In various examples product data from a retailer inventory such as numbers of remaining units of a product, is available to an advertising server by querying a retailer inventory. In various examples a retailer is able to create an advertisement design for a selling period; the design is used to dynamically generate advertisements in response to advertisement impression requests from information retrieval systems, dedicated sales sites, and other entities. In various examples, prices, minimal bids and other data is calculated using data retrieved from a retailer inventory and input to advertisements generated for display at end user devices. In an example group buying is facilitated by generating advertisements stating a current number of participants out of a target number of participants.

### BACKGROUND

Existing advertisement systems are able to generate advertisements for display at user interfaces in conjunction with other services that a user is accessing on his or her computing device. For example, advertisements are typically displayed together with search results where a user accesses an information retrieval system. Advertisements are also displayed at dedicated auction sites, or at other dedicated sales sites and in conjunction with other services such as interne based news services.

Advertisers typically design or generate advertisements for display and provide these to an advertising service or directly to dedicated sales sites operated by the advertiser. The process of generating and updating the advertisements is time consuming and complex for the advertisers. Often manual processes are involved which are error prone.

The embodiments described below are not limited to implementations which solve any or all of the disadvantages of known advertisement systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

An advertisement system which uses a retailer inventory is described, for example, to dynamically generate advertisements with data from the retailer inventory. In various examples product data from a retailer inventory such as numbers of remaining units of a product, is available to an advertising server by querying a retailer inventory. In various examples a retailer is able to create an advertisement design for a selling period; the design is used to dynamically generate advertisements in response to advertisement impression requests from information retrieval systems, dedicated sales sites, and other entities. In various examples, prices, minimal bids and other data is calculated using data retrieved from a retailer inventory and input to advertisements generated for display at end user devices′. In an example group buying is facilitated by generating advertisements stating a current number of participants out of a target number of participants.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an advertisement system used together with a retailer inventory;

FIG. 2 is a flow diagram of a method at the advertisement system of FIG. 1;

FIG. 3 is a flow diagram of another method at an advertisement system;

FIG. 4 is a flow diagram of a method at an advertisement system for auction advertisements;

FIG. 5 is a flow diagram of a method at an advertisement system for a group buying advertisement;

FIG. 6 illustrates an exemplary computing-based device in which embodiments of an advertisement system may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

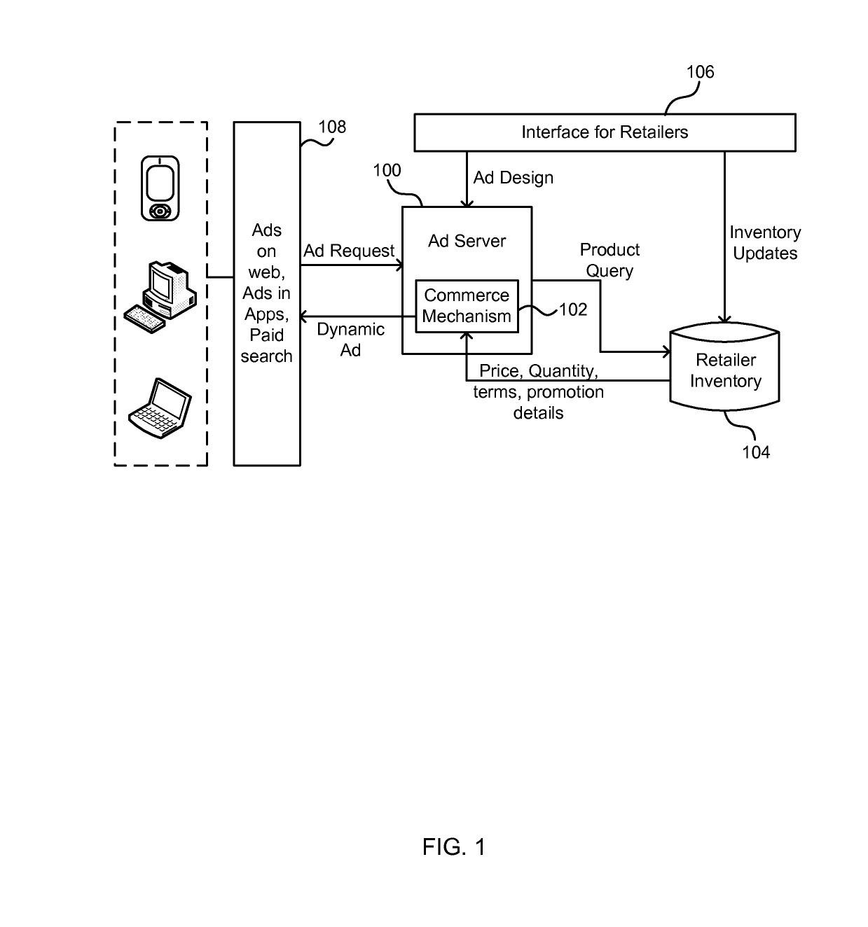

FIG. 1 is a schematic diagram of an advertisement system used together with at least one retailer inventory 104. The advertisement system comprises an advertisement server 100 and a commerce mechanism 102 both of which are computer implemented using software and/or hardware. The commerce mechanism may be integral with the advertisement server 100 as shown in FIG. 1 although that is not essential; the commerce mechanism may be separate from the advertisement server and located at another entity which is in communication with the advertisement server over a communications network of any type.

In the example of FIG. 1 a single retailer inventory 104 is illustrated for clarity. However, in practice many retailer inventories may be present. A single retailer inventory may comprise product data of products stocked by more than one retailer.

The advertisement server is arranged to receive advertisement requests from requesting entities 108. For example, a requesting entity may be an end user device such as a smart phone, a personal computer, a laptop computer or any other end user computing device which is able to display advertisements. A requesting entity may also be an information retrieval system; for example, where advertisements are placed together with search results for display at end user devices. A requesting entity may be a web-based service which provides an application to end user devices. The web-based service may place advertisements for display as part of the application at end user devices. A requesting entity may be a web-based service such as a news site at which end users are able to browse articles about current affairs. The news site may display advertisements adjacent to the news articles.

The advertisement server is arranged to send dynamically created advertisements to an end user device in response to an advertisement request. The advertisement is dynamically created by the advertisement server 100 using results from the commerce mechanism 102 and using an advertisement design. For example, the advertisement may state a quantity of items remaining for sale as indicated by the retailer inventory. The advertisement may include a price calculated by the commerce mechanism on the basis of data from the retailer inventory and optionally other information. The advertisement may include an auction floor price calculated by the commerce mechanism on the basis of data from the retailer inventory and optionally other information. The advertisement may include a tally of a number of purchasers wishing to participate in a group buying opportunity where the tally is maintained by the retailer inventory.

The advertisement server receives advertisement designs from an interface 106 for retailers. The interface 106 may be a web-based interface provided by the advertisement server 100 and which enables retailers to create advertisement designs. For example, an advertisement for a laptop computer may show a picture or video of the product and may comprise pricing, product information, a link to the retailer's dedicated sales site, and information about how many of the products are left in stock. In the advertisement design the retailer may specify which graphics to use, which price to display, which links to include and may specify a field for the stock and/or group buy information which is to be populated dynamically using data from the retailer inventory.

The interface 106 may comprise one or more template advertisement designs available for the retailer to choose from. The templates may be tailored to different sales scenarios, such as an auction, a group buy opportunity, a limited time sales promotion. A template advertisement design may comprise fields for video, photographs or other graphics, fields for text and fields for dynamically populated data.

If an advertisement impression is successfully converted into a sale the retailer updates the retailer inventory as indicated by the arrow labeled “inventory updates” in FIG. 1. The retailer may also update the inventory 104 for other reasons, for example, if fresh goods reach their expiry date, if stock becomes damaged or for other reasons. In some examples, the retailer may sell items through other channels and in this case, the retailer may update the inventory. The retailer may update the inventory in any suitable manner, for example, in an automated process using data from a sales system, manually or in semi-automated ways. For example, the retailer may use interface 106 to update the retailer inventory although other inputs to the retailer inventory 104 may also be used.

The retailer inventory 104 may be a database or any other store holding data about products a retailer has in stock available for sale. The data about the products may comprise prices, product descriptions, products which may be substituted for other products, product sources, numbers of products in stock, product expiry dates, terms and promotion details.

The retailer inventory 104 is able to receive queries from the advertisement server 100. Each query may be associated with a particular product, for example, by containing a product identifier. For example, a query may request a number of a particular product which is currently in stock. A query may request a number of potential purchasers currently requesting membership, directly through the retailer, of a group buying scheme for a particular product, allowing the system to combine this number with the number of potential purchasers that joined through the auction system. A query may request a price of a particular product. Combinations of one or more query may be used. Other queries are also possible.

The retailer inventory 104 is able to look up answers to the queries and send responses to the advertisement server 100. The responses may comprise information such as stock levels, group buy tallies, prices and other product information from the retailer inventory 104. The responses may comprise terms and promotion details.

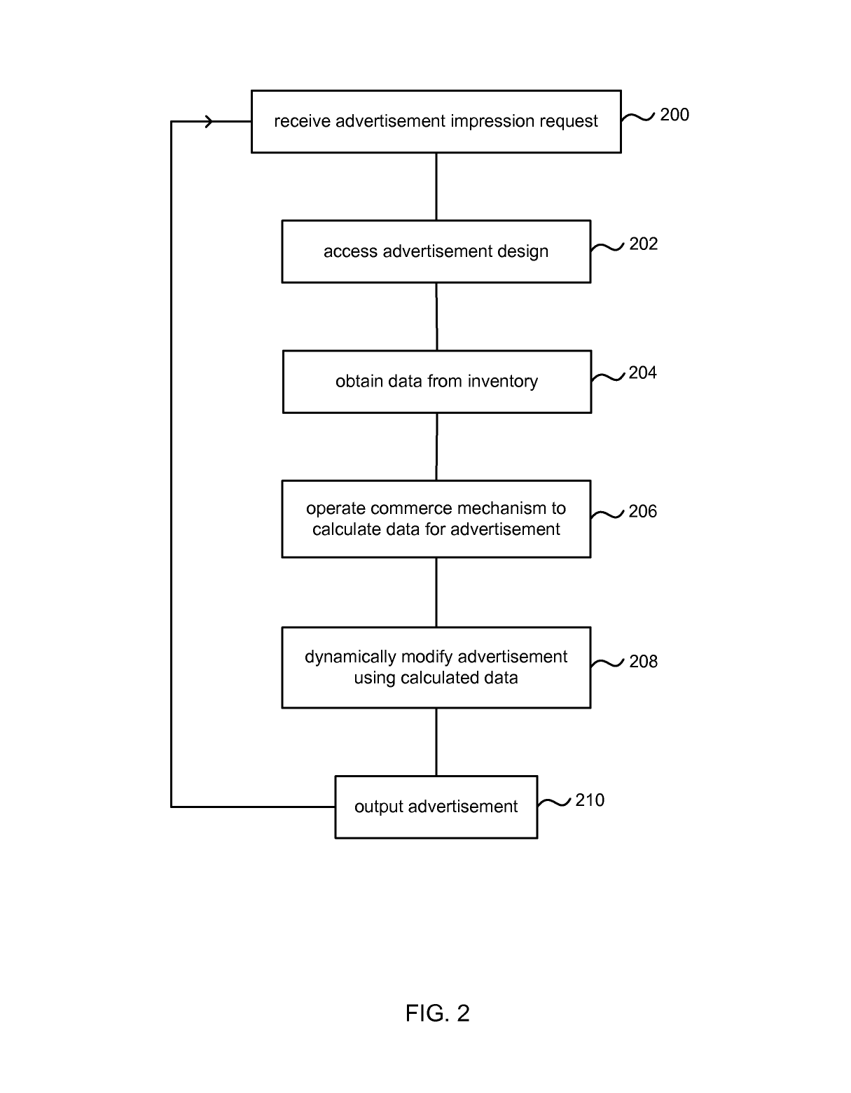

FIG. 2 is a flow diagram of a method at the advertisement system of FIG. 1. In this example an advertisement impression request is received 200 at the advertising server 100. The advertisement impression request may comprise an identifier of a retailer and/or product. The advertisement impression request may comprise an identifier of an advertisement design.

The advertisement system accesses 202 an advertisement design which is associated with the advertisement impression request. For example, it selects an advertisement design input by the identified retailer for an identified product. It may select an advertisement design which is specified in the request.

The advertisement system obtains 204 data from the retailer inventory 104. This is done by identifying fields of the advertisement design which are to be filled with dynamic data. The advertisement system determines, using rules, criteria or other information, what data is to be retrieved from the retailer inventory 104. It sends one or more queries to the retailer inventory 104 to obtain the data and uses that to calculate data for dynamically filling the advertisement design field. For example, the commerce mechanism 102 may calculate 206 the data for dynamically filling the advertisement design field.

For example, the commerce mechanism 102 may use data retrieved from the retailer inventory and optionally other data to calculate data for dynamically filling the advertisement design field. Where users have given their consent, the other data may comprise one or more of: information about the user's location, a number of times the user received a specified advertisement impression, an observed web history of the user.

The advertisement system dynamically modifies 208 the advertisement by using the advertisement design to create an instance of an advertisement which is filled with the calculated data. The created advertisement is output 210 by the advertisement system and sent to the end user device either directly or via one or more other entities.

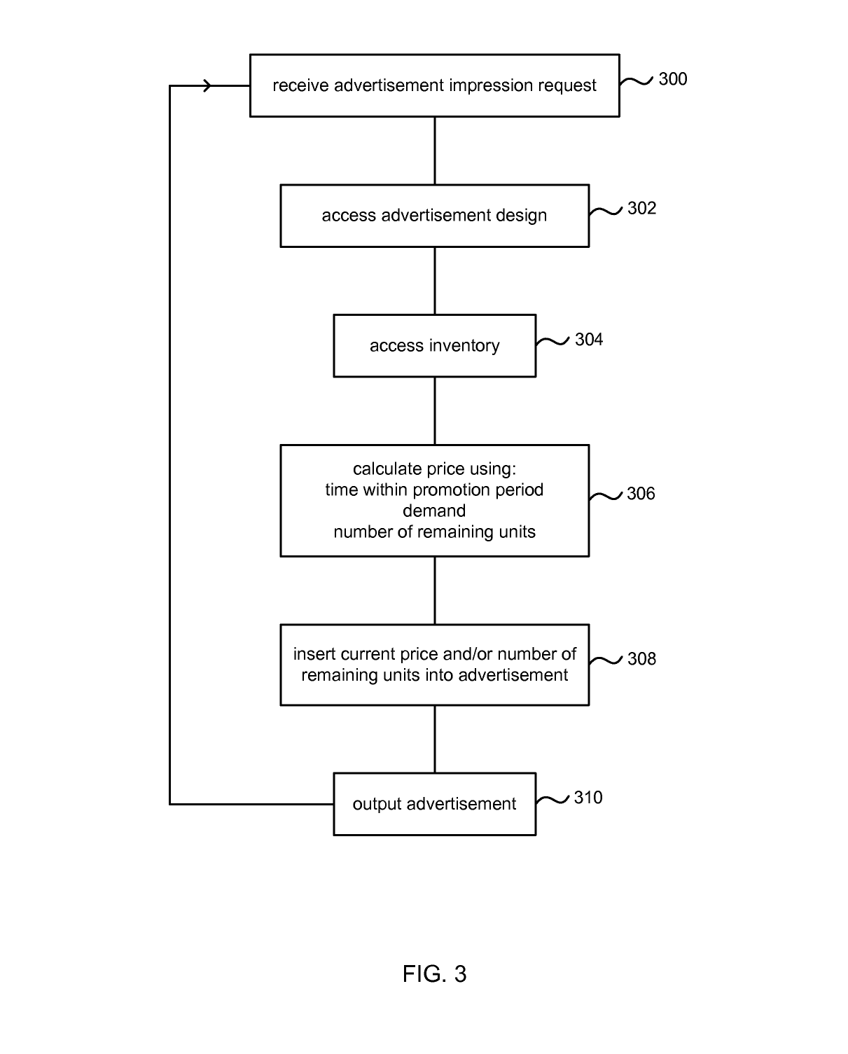

FIG. 3 is a flow diagram of another method at an advertisement system such as that of FIG. 1. In this example, a retailer is running a promotion on her online site where the price declines over time based on demand on timing with a promotion (clearance) cycle. A display advertisement is created once for the campaign and, each time it is presented, the number of remaining units on promotion and the current price are stated in the advertisement.

In this example an advertisement impression request is received 300 at the advertising server 100. The advertisement impression request may comprise an identifier of a retailer and/or product. The advertisement impression request may comprise an identifier of an advertisement design.

The advertisement system accesses 302 an advertisement design which is associated with the advertisement impression request. For example, it selects an advertisement design input by the identified retailer for an identified product. It may select an advertisement design which is specified in the request. The advertisement design has fields for the number of remaining units on promotion and the current price.

The advertisement system accesses 304 the retailer inventory 104. The advertisement system sends one or more queries to the retailer inventory 104 to obtain the number of remaining units of the specified product. It also obtains data related to demand for the product. For example, the frequency of decrements to the number of remaining units. The commerce mechanism uses the responses received from the retailer inventory, together with its own knowledge of the time remaining within the promotion period (from the advertisement design) to calculate a current price.

The advertisement system inserts 308 the calculated current price and/or the number of remaining units on promotion into an advertisement created using the design. The created advertisement is output 310 by the advertisement system and sent to the end user device either directly or via one or more other entities.

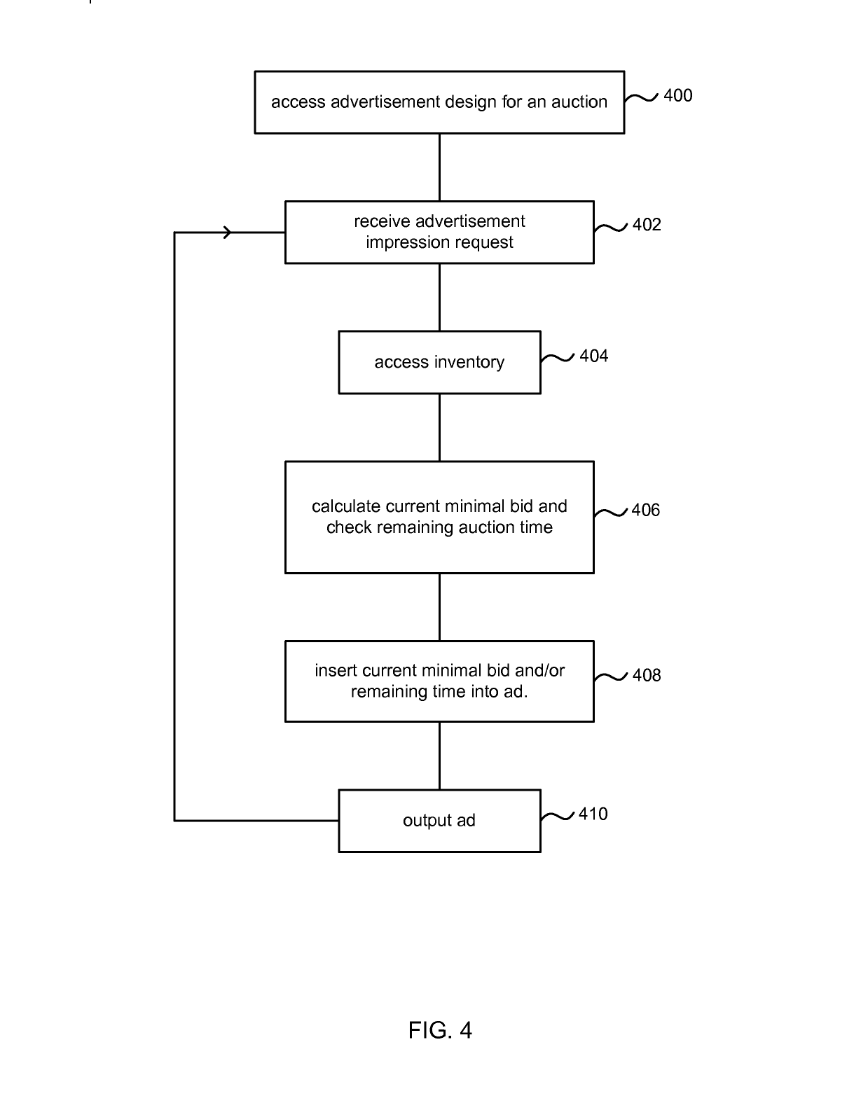

FIG. 4 is a flow diagram of another method at an advertisement system such as that of FIG. 1. In this example a retailer desires to sell multiple units on auction at the retailer's own online commerce site. The retailer creates an advertisement design once for the auction period. Each time an advertisement according to the design is presented, the advertisement states a current minimal bid (floor price) and a remaining time for the auction.

In this example an advertisement impression request is received 402 at the advertising server 100. The advertisement impression request may comprise an identifier of a retailer and/or product. The advertisement impression request may comprise an identifier of an advertisement design.

The advertisement system accesses 400 an advertisement design which is associated with the advertisement impression request. For example, it selects an advertisement design input by the identified retailer for an identified product. It may select an advertisement design which is specified in the request. The advertisement design has fields for a minimal bid and the remaining auction time.

The advertisement system accesses 404 the retailer inventory 104. The advertisement system sends one or more queries to the retailer inventory 104 to obtain the number of remaining units of the specified product. The commerce mechanism uses the response received from the retailer inventory, together with its own knowledge of the time remaining within the auction period (from the advertisement design) to calculate 406 a current minimal bid for the auction. This is used where a series of auctions takes place, each having a new minimal bid.

The advertisement system inserts 408 the calculated minimal bid and the remaining auction time into an advertisement created using the design. The created advertisement is output 410 by the advertisement system and sent to the end user device either directly or via one or more other entities.

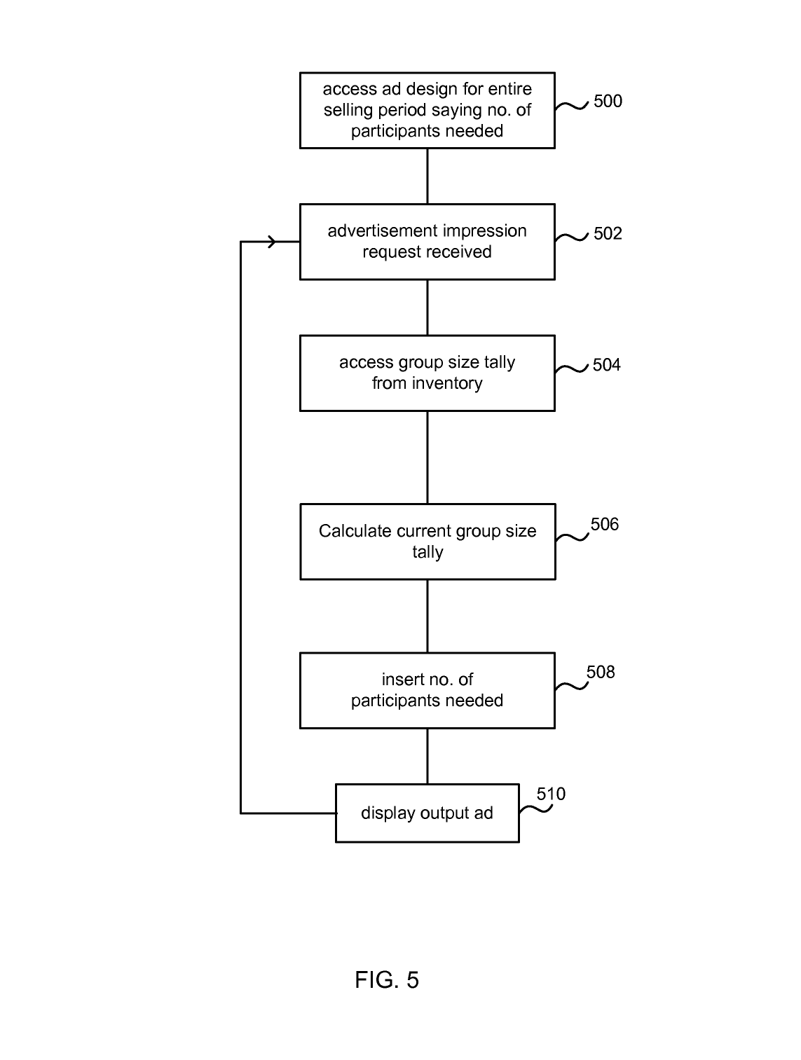

FIG. 5 is a flow diagram of a method at an advertisement system for a group buying advertisement. In this example a retailer desires to sell products on an online commerce site using a group buying mechanism where a minimal number of units are to be sold in order to guarantee a discounted price. The advertisement design is created once for the entire selling period and is able to show dynamically the size of the group being formed for the promotion.

In this example an advertisement impression request is received 502 at the advertising server 100. The advertisement impression request may comprise an identifier of a retailer and/or product. The advertisement impression request may comprise an identifier of an advertisement design.

The advertisement system accesses 500 an advertisement design which is associated with the advertisement impression request. For example, it selects an advertisement design input by the identified retailer for an identified product. It may select an advertisement design which is specified in the request. The advertisement design has a dynamic display to indicate the current number of participants in the group buying opportunity and the number of participants left to be found to meet the group buying criteria. For example, the display may take the form of a bar which is filled with color in proportion to the current number of participants.

The advertisement system uses the retailer inventory 104 to access 504 the number of participants who joined the scheme directly; that is, without using the online advertisements. For example, these may be participants who joined from the retailer's store. The advertisement system also knows the number of participants who have joined the scheme through the online advertisements. The advertisement system is then able to calculate 506 the current group size tally; that is the total number of participants currently in the scheme. The advertisement system inserts 508 the number of participants needed to meet the group buying criteria into the advertisements. For example, it updates a bar (or other text or graphical display) at the advertisement showing the current number of participants as a proportion of the total number needed. The created advertisement is output 510 by the advertisement system and sent to the end user device either directly or via one or more other entities.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), graphics processing units (GPUs).

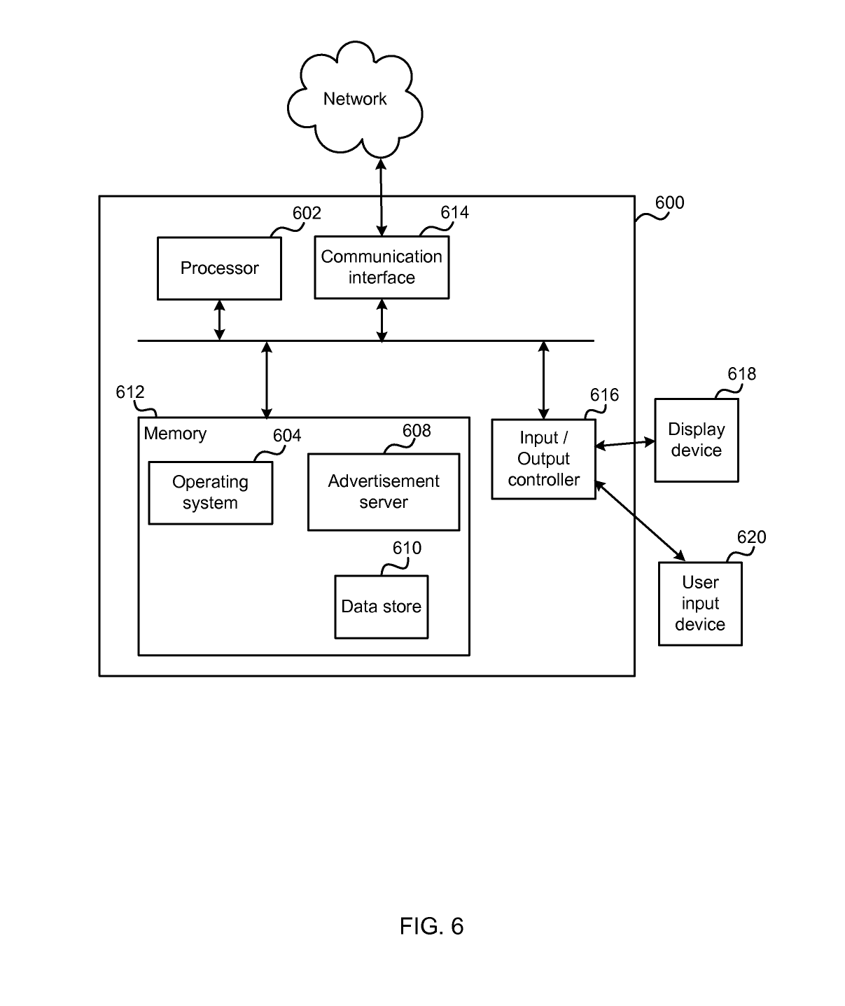

FIG. 6 illustrates various components of an exemplary computing-based device 600 which may be implemented as any form of a computing and/or electronic device, and in which embodiments of an advertisement system may be implemented.

Computing-based device 600 comprises one or more processors 602 which may be microprocessors, controllers or any other suitable type of processors for processing computer executable instructions to control the operation of the device in order to dynamically generate advertisements using information from one or more retailer inventories. In some examples, for example where a system on a chip architecture is used, the processors 602 may include one or more fixed function blocks (also referred to as accelerators) which implement a part of the method of dynamically generating advertisements using retailer inventory data in hardware (rather than software or firmware). Platform software comprising an operating system 604 or any other suitable platform software may be provided at the computing-based device to enable application software to be executed on the device. The computer executable instructions may give functionality of an advertisement server 608 able to carry out the methods described herein.

The computer executable instructions may be provided using any computer-readable media that is accessible by computing based device 600. Computer-readable media may include, for example, computer storage media such as memory 612 and communications media. Computer storage media, such as memory 612, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 612) is shown within the computing-based device 600 it will be appreciated that the storage may be distributed or located remotely and accessed via a network or other communication link (e.g. using communication interface 614).

The computing-based device 600 also comprises an input/output controller 616 arranged to output display information to a display device 618 which may be separate from or integral to the computing-based device 600. The display information may provide a graphical user interface. The input/output controller 616 is also arranged to receive and process input from one or more devices, such as a user input device 620 (e.g. a mouse, keyboard, camera, microphone or other sensor). In some examples the user input device 620 may detect voice input, user gestures or other user actions and may provide a natural user interface (NUI). This user input may be used to input advertisement designs, set criteria, rules or thresholds, specify an address of a retailer inventory and for other purposes. In an embodiment the display device 618 may also act as the user input device 620 if it is a touch sensitive display device. The input/output controller 616 may also output data to devices other than the display device, e.g. a locally connected printing device.

Any of the input/output controller 616, display device 618 and the user input device 620 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method comprising:
receiving, at a processor, an advertisement impression request;
accessing an advertisement design associated with the advertisement impression request;
obtaining data from a retailer inventory about one or more products specified in the advertisement design;
dynamically generating an advertisement according to the advertisement design and using the obtained data.

2. A method as claimed in claim 1 wherein obtaining data from a retailer inventory comprises sending a query to the retailer inventory, the query comprising a product identifier, and receiving a response from the retailer inventory.

3. A method as claimed in claim 1 comprising outputting the generated advertisement for display at an end user device.

4. A method as claimed in claim 1 wherein obtaining data from the retailer inventory comprises obtaining a number of remaining units of a product.

5. A method as claimed in claim 1 wherein obtaining data from the retailer inventory comprises obtaining data relating to demand for the product.

6. A method as claimed in claim 1 wherein obtaining data from the retailer inventory comprises obtaining a current group size tally of a group buying opportunity.

7. A method as claimed in claim 1 comprising calculating a price at least on the basis of the obtained data and dynamically generating the advertisement using the calculated price.

8. A method as claimed in claim 1 comprising calculating a price on the basis of the obtained data and a time within a promotion period and dynamically generating the advertisement using the calculated price.

9. A method as claimed in claim 1 comprising calculating a minimal bid of an auction on the basis of the obtained data and dynamically generating the advertisement using the calculated minimal bid.

10. A method as claimed in claim 1 comprising dynamically generating the advertisement by creating a graphical display which indicates a proportion of a number of participants needed for a group buying opportunity that are currently available.

11. A method comprising:
receiving, at a processor, an advertisement impression request;
accessing an advertisement design associated with the advertisement impression request;
obtaining data from a retailer inventory about one or more products specified in the advertisement design;
calculating a price at least on the basis of the obtained data;
dynamically generating an advertisement, including at least the calculated price and according to the advertisement design.

12. A method as claimed in claim 11 wherein the price is a minimal bid of an auction.

13. A method as claimed in claim 11 wherein calculating the price is achieved on the basis of the obtained data and on the basis of a time.

14. A method as claimed in claim 11 wherein calculating the price is achieved on the basis of data relating to demand for the product which is obtained from the retailer inventory.

15. A method as claimed in claim 11 comprising dynamically generating the advertisement such that it includes a number of remaining units of a product.

16. An advertisement server comprising:
an input arranged to receive an advertisement impression request;
a processor arranged to access an advertisement design associated with the advertisement impression request;
the processor arranged to obtain data from a retailer inventory about one or more products specified in the advertisement design;
the processor arranged to dynamically generate an advertisement according to the advertisement design and using the obtained data.

17. An advertisement server as claimed in claim 16 arranged to send a query to the retailer inventory, the query comprising a product identifier, and to receive a response from the retailer inventory.

18. An advertisement server as claimed in claim 16 the processor arranged to obtain data from the retailer inventory comprising a number of remaining units of a product.

19. An advertisement server as claimed in claim 16 the processor arranged to obtain data from the retailer inventory comprising data relating to demand for the product.

20. An advertisement server as claimed in claim 16 at least partially implemented using hardware logic selected from any one or more of: a field-programmable gate array, a program-specific integrated circuit, a program-specific standard product, a system-on-a-chip, a complex programmable logic device.
